(19) United States
(12) Patent Application Publication
(10) Pub. No.: US 2013/0182728 A1
(43) Pub. Date: Jul. 18, 2013

(54) WAVELENGTH TUNABLE EXTERNAL CAVITY LASER

(71) Applicant: Ruolin Li, Milpitas, CA (US)

(72) Inventor: Ruolin Li, Milpitas, CA (US)

(73) Assignee: Mars Technology.

(21) Appl. No.: 13/349,424

(22) Filed: Jan. 12, 2012

(51) Int. Cl. H01S 3/10

(52) U.S. Cl. 372/20

(57) ABSTRACT

In accordance with aspects of the present disclosure, a wavelength tunable laser and a method for wavelength tuning a laser is disclosed. The wavelength tunable laser can include an active portion including a photonic integrated circuit including an optical waveguide including an optical gain section, a grating section, a phase control section and an anti-reflection coating arranged at opposite ends of the optical waveguide; a passive portion including an optical etalon and a reflective mirror arranged to provide feedback to the active portion to generate beam of laser light; and a controller arranged to control the active portion, the passive portion or both the active portion and the passive portion to generate tuning of the lasing wavelength.

### DESCRIPTION OF THE DISCLOSURE

1. Field of the Disclosure

The present application is directed to wavelength tunable lasers, and in particular, to a wavelength tunable external cavity laser which can be operated at continuously or selectively variable frequencies covering a wide wavelength range.

2. Background of the Disclosure

As the light source for the WDM transmission system, DFB (Distributed Feedback) Laser has been used widely because it is easy to fabricate and handle and highly reliable. In the DFB, a diffraction grating is formed over the entire region of an active resonator, and a stable single mode lasing can be obtained at a fixed wavelength. Direct modulation on DFB is also possible for low data rate application.

However, the DFB is not capable of tuning over a wide range of wavelengths, so that the WDM system is constituted by using lasers of different wavelength for each ITU grid. Thus, it is necessary to use different lasers for each wavelength, which causes an increase in the cost for wavelength management, and requires a surplus inventory of laser backup for dealing with breakdown, etc.

To overcome such shortcoming of the current DFB laser and achieving single-mode operation with a wide range of wavelengths, tunable lasers have been demanded and developed. A single tunable laser can serve as a back-up for multiple channels or wavelengths sources so that fewer WDM transponders are needed in stock for spare parts. Tunable lasers can also provide flexibility at multiplexing locations, where wavelengths can be added and dropped from fibers as needed. Accordingly, tunable lasers can help carriers effectively manage wavelengths throughout a fiber optics network.

Tunable lasers can be classified roughly into two types; one is a type where a tuning mechanism is provided within a laser element and the other is a type where a tuning mechanism is provided outside the laser element. For the former case, there has been proposed a DBR (Distributed Bragg Reflector) laser diode in which an active region for generating the gain and a DBR region for generating reflection are formed within the same laser element. The tunable range of the DBR is about 10 nm at the most.

What is needed is an improved design for a tunable laser system, and in particular a tunable laser system that can be suitable for use in WDM applications.

### SUMMARY OF THE DISCLOSURE

In accordance with aspects of the disclosure, a wavelength tunable laser is disclosed that can comprise an active portion comprising a photonic integrated circuit comprising an optical waveguide comprising an optical gain section, a grating section, a phase control section and an anti-reflection coating arranged at opposite ends of the optical waveguide; a passive portion comprising an optical etalon and a reflective mirror, for example an Etalon and the mirror can together act as external feedback, arranged to provide feedback to the active portion to generate beam of laser light; and a controller arranged to control the active portion, the passive portion or both the active portion and the passive portion to generate tuning of the lasing wavelength.

In some aspects, the optical gain section can be arranged between the grating section and the phase control section.

In some aspects, the passive portion can comprise an optical element arranged to receive and collimate radiation emitted from the optical waveguide and provide the radiation to the optical etalon and a mirror comprising a reflective surface arranged to receive radiation transmitted by the optical etalon and reflect the radiation back to the optical etalon.

In some aspects, the gain section of the optical waveguide can be arranged to create a spontaneous emission of photons over a bandwidth around a center frequency.

In some aspects, the grating section Of the optical waveguide can be arranged to partially reflect photons back to the optical gain section at selective wavelengths.

In some aspects, the phase section of the optical waveguide can be arranged to control an optical path length and provide a coherent phase condition for the radiation.

In some aspects, the controller can be arranged to control one or more electrodes coupled to the active portion to selectively adjust a refractive index of the active portion.

In some aspects, the controller can be arranged to control one or more heating elements coupled to the active portion to selectively adjust a refractive index of the active portion.

In some aspects, the controller can be arranged to control one or more electrodes coupled to the passive portion to selectively adjust a refractive index of the etalon.

In some aspects, the controller can be arranged to control one or more heating elements coupled to the passive portion to selectively adjust a refractive index of the etalon.

In some aspects, the controller can be arranged to allow the wavelength tunable laser to be operated continuously or selectively to produce radiation at a range of wavelengths.

In some aspects, the optical etalon can include a transmission spectrum that includes one or more comb-like maxima.

In some aspects, the optical etalon can be arranged to provide a wavelength filter for the optical waveguide.

In some aspects, the grating section of the optical waveguide can include a sampled grating or a superstructure grating with a comb reflection structure.

In some aspects, the optical etalon and the grating can be arranged to provide differently spaced wavelength sections having maxima transmission and reflection points providing a maximum reflection of an associated wavelength.

In accordance with aspects of the present disclosure, a wavelength tunable laser is disclosed that can include an active portion comprising an optical waveguide comprising a phase control section near a first end, a grating section near a second end and a gain section arranged between the first and the second end of the waveguide, wherein the first end comprises a first antireflection coating and the second end comprising a second antireflection coating; a passive portion comprising a first optical element arranged to receive and collimate radiation emitted from the optical waveguide; an optical etalon; a second optical element comprising a reflective surface arranged to receive radiation transmitted by the optical etalon and reflect the radiation back to the optical etalon; and a controller arranged to control the active portion, the passive portion or both the active portion and the passive portion to generate tuning of the lasing wavelength.

In some aspects, the controller can be arranged to control one or more electrodes, one or more heating elements, or both the one or more electrodes and the one or more heating elements coupled to the active portion, the passive portion, or both the active portion and the passive portion to selectively adjust a refractive index of the active portion, the passive portion, or both the active portion and the passive portion.

In accordance with aspects of the present disclosure, a method for wavelength tuning a laser is disclosed. The method can include providing an active portion comprising a photonic integrated circuit comprising an optical waveguide comprising an optical gain section, a grating section, a phase control section and an anti-reflection coating arranged at opposite ends of the optical waveguide; providing a passive portion comprising an optical etalon and a reflective mirror arranged to provide a wavelength selective feedback to the active portion to generate beam of laser light; and controlling, by a controller, the active portion, the passive portion or both the active portion and the passive portion to generate tuning of the lasing wavelength.

In some aspects, the controller can be arranged to control one or more electrodes, one or more heating elements, or both the one or more electrodes and the one or more heating elements coupled to the active portion, the passive portion, or both the active portion and the passive portion to selectively adjust a refractive index of the active portion, the passive portion, or both the active portion and the passive portion.

Generally, the tunable laser, in accordance with the various aspects of the present disclosure, is based on hybrid integration of a photonic integrated circuit that is arranged as a light source and a free-space optical assembly comprising a first optical element, such as a lens, a free-space etalon filter, and a second optical element including a highly reflecting surface as an external cavity. The multi-section photonic integrated circuit can include a gain section to create a spontaneous emission of photons over a bandwidth around a particular center frequency, a reflection grating section to partially reflect photons back to active section at selective wavelengths, and a phase section to control the optical path length to provide a coherent phase condition.

The transmission spectrum of the etalon is arranged to exhibit comb-like maxima and acts as additional wavelength filter in the laser cavity; and operate with the highly reflective surface to provide an external feedback to the active section of the photonic integrated circuit with a comb-like reflection over broad range of wavelength.

The photons generated in the active section are reflected between the grating reflector at one side and the external optical feedback at the other side of the gain section to generate coherent resonance to create an emitted beam of laser light. The first optical element can be arranged to expand and focus the light in between active photonic integrated circuit and passive external cavity region. The grating reflector can be either of a sampled grating or superstructure grating with a comb reflection structure. The etalon and the grating reflector can be arranged to provide two differently spaced wavelength selections having maxima transmission and reflection points providing a maximum reflection of an associated wavelength.

With the spacing of transmission and reflection maxima points of the respective wavelength being different, only one transmission maximum of the etalon and reflection maximum of the grating filter can be aligned in correspondence to a wavelength at a time, to produce a laser emission at that single wavelength. Magnitude of reflection from other comb peaks of either sampled grating/super-structure grating or the external cavity is not sufficient to cause lasing.

Since single mode lasing happens only at peak transmission wavelength of the etalon for such an external cavity laser, when the etalon is compatible to meet channel wavelength requirement of ITU grid for telecommunication, the wavelength of the laser is pre-defined to be ITU-compatible and no external wavelength control or reference is needed in operation.

A tuning mechanism can be built in the etalon, the reflection grating or both to generate step or quasi-continuous tuning of the said lasing wavelength. When both etalon and grating reflector are tuned to provide a low loss window at any time and thereby generate lasing condition, the output of such laser is wavelength tunable.

Additional embodiments and advantages of the disclosure will be set forth in part in the description which follows, and can be learned by practice of the disclosure. The embodiments and advantages of the disclosure will be realized and attained by means of the elements and combinations particularly pointed out in the appended claims.

It is to be understood that both the foregoing general description and the following detailed description are exemplary and explanatory only and are not restrictive of the disclosure, as claimed.

The accompanying drawings, which are incorporated in and constitute a part of this specification, illustrate several embodiments of the disclosure and, together with the description, serve to explain the principles of the disclosure.

### BRIEF DESCRIPTION OF TILE DRAWINGS

FIGS. 1a (top) and 1b (bottom) are perspective top and side views, respectively, of an example optical assembly of wavelength selective laser in accordance with aspects of the present disclosure.

FIGS. 2a and 2b show the comb-like spectrum of an etalon (dashed curve) transmission and the sampled/superstructure grating reflection (solid curve) in accordance with aspects of the present disclosure.

FIGS. 3a (top) and 3b (bottom) are perspective top and side views, respectively, of another example optical assembly of wavelength tunable laser in accordance with aspects of the present disclosure.

### DESCRIPTION OF THE EMBODIMENTS

Reference will now be made in detail to various exemplary embodiments of the present application, examples of which are illustrated in the accompanying drawings. Wherever possible, the same reference numbers will be used throughout the drawings to refer to the same or like parts.

Generally, the aspects of the present disclosure describe a wavelength tunable laser device comprising an active semiconductor photonic integrated circuit (IC), an optical element, such as a lens, an etalon, and another optical element having highly reflective surface. The active photonic IC can include a gain section for photon generation, a phase control section, and a grating reflector section. The wavelength sweeping of the laser device can be implemented through alignment of the transmission spectrum of the etalon and the reflection spectrum of the grating. Tuning of the laser device can be performed though a local heating of the waveguide sampled/superstructure grating reflector or/and the etalon filter.

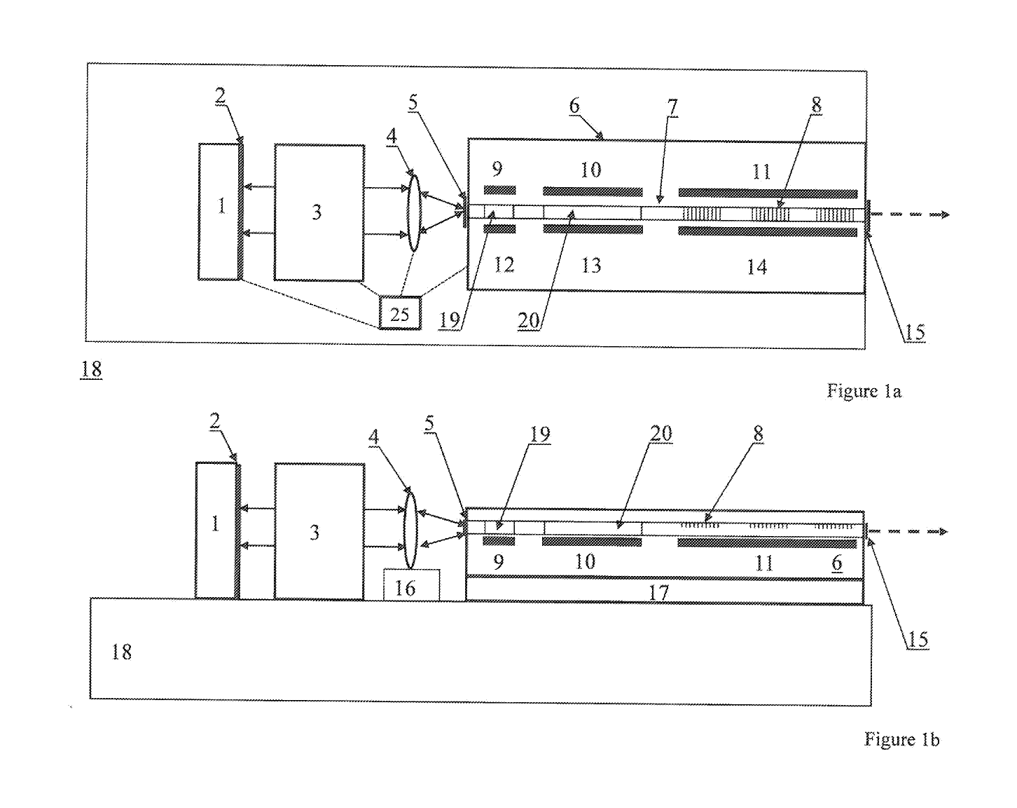

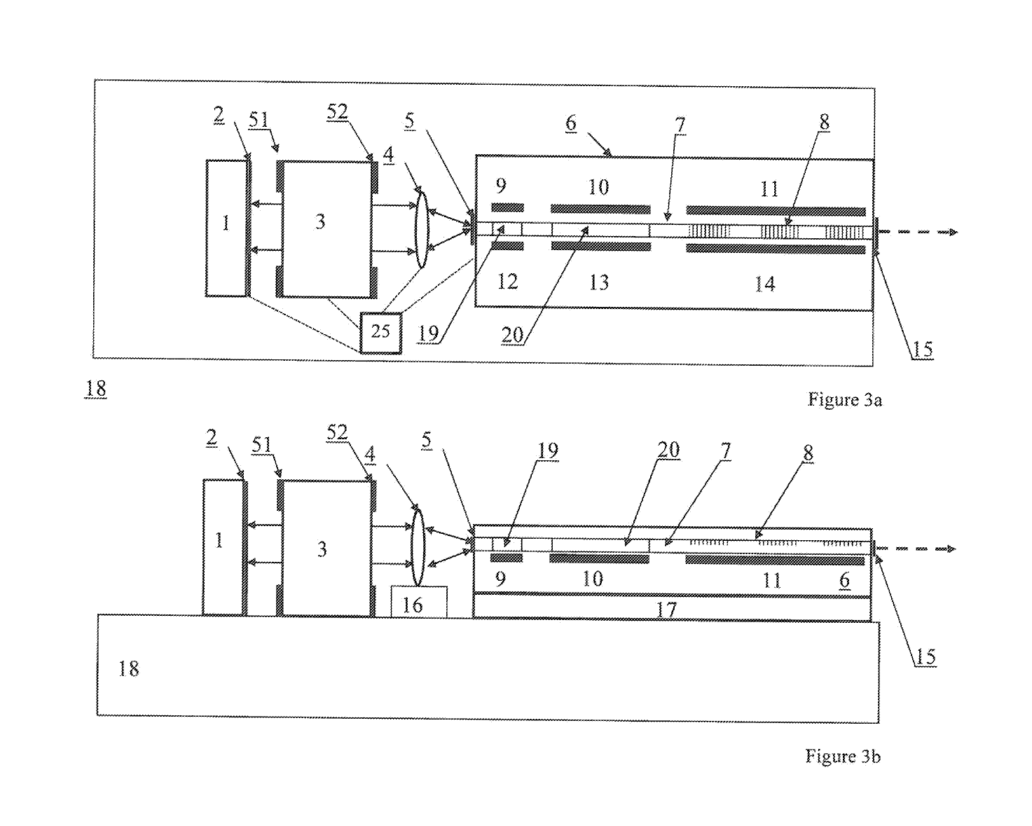

FIGS. 1a (top view) and 1b (side view) show an example wavelength tunable laser device in accordance with aspects of the present disclosure. The laser device comprises an active component portion and a passive component portion. The active component portion comprising an external cavity laser comprising active photonic integrated circuit 6 arranged on mount 17 and arranged to function as a light source. The passive component portion comprises a micro-optical assembly comprising optical element 4, such as an optical lens, arranged on mount 16, etalon 3, such as a free-space etalon filter, and another optical element 2, arranged to be mounted to mount 1, having a reflective surface that functions as a high reflector. The passive components can be arranged as an external cavity that when coupled to the active component portion functions as the tunable laser device. Controller 25, as shown in FIGS. 1a and 3a, can be arranged to control the active and/or passive components in the laser device.

Active photonic integrated circuit 6 can be made of a compound semiconductor material having waveguide core 7. Waveguide 7 comprises grating reflector section 8, gain section 20, and phase section 19. Each section can have a set of local electrodes 9-14 around waveguide 7. Photonic integrated circuit 6 can have anti-reflection coating 5 and 15 on both end facets of waveguide 7.

In gain section 20, electrodes 10 and 13 are arranged to inject electrons into active waveguide region to generate spontaneous emission for broad band photon around a center, wavelength through electron-photon conversion. Phase section 19 is arranged next to gain section 20 on its left side in FIG. 1 and is arranged to control an optical path length, i.e., the product of the refractive index of and the physics distance light traveled in waveguide, to provide a phase-matching coherent condition for lasing. In some aspects, phase section 19 operates through a thermo-optical effect, i.e., the refractive index of the waveguide is changed by temperature by changing the refractive index of the waveguide with temperature, which can be changed by a local heating from the electrodes. Additionally or alternatively, the refractive index can be adjusted by the electrodes through an electrical-optical effect where the refractive index of the waveguide is changed by the carrier injection upon applying electrical current on the electrodes.

Grating reflector 8 is arranged to partially reflect photons at selective wavelengths back to gain section 20 for optical amplification. The reflection wavelength of grating reflector 8 can be changed or tuned through thermal-optical or electric-optical effects, discussed above, by local electrodes 11&14 around waveguide 7.

As shown in FIGS. 1a and 1b, the light emission exiting the left waveguide facet 5 of the active chip 6 is collimated by optical element 4, such as a lens, transmitted by etalon 3, and incident on optical element 2 having a high reflective surface where radiation is reflected and sent back along same path to active chip 6 for amplification.

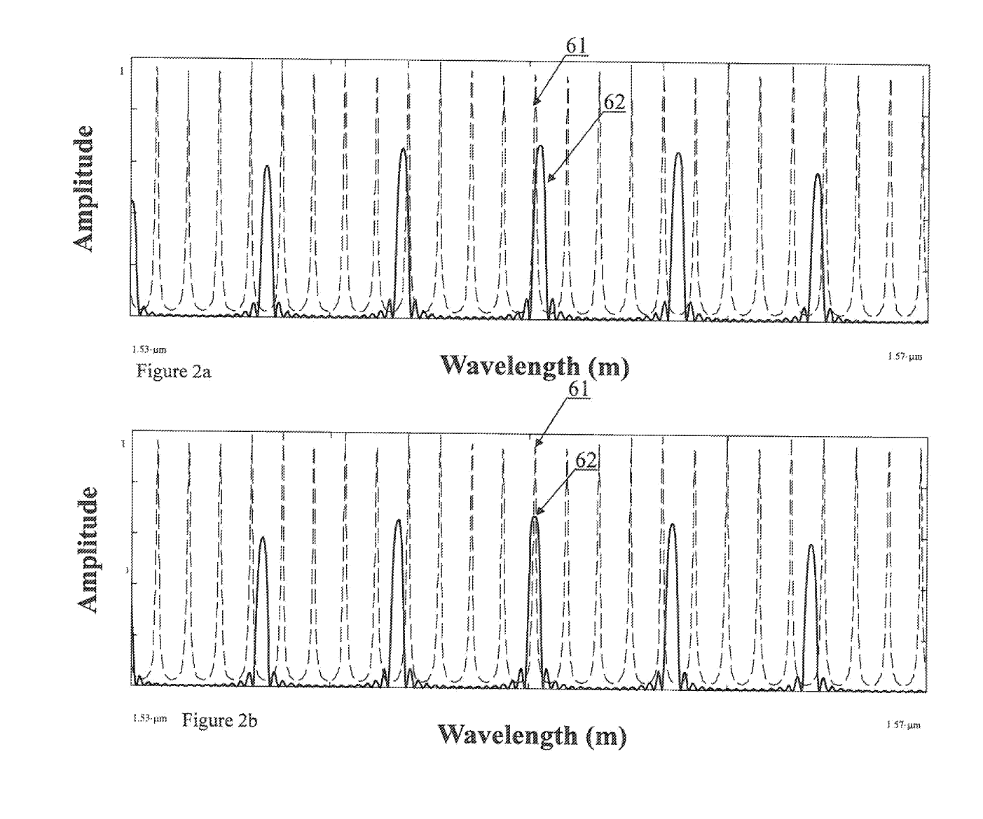

Etalon 3 is arranged to exhibit a transmission spectrum with comb-like maxima as shown as dashed line in FIGS. 2a and 2b; the wavelength separation between the neighboring comb maxima is called free-spectra-range (FSR). Etalon 3 is arranged to act as additional wavelength filter in the laser cavity and works together with optical element 2 to construct an external feedback to active chip 6 with a comb-like reflection over broad range of wavelength when the radiation is incident on etalon 3 from the right side (FIGS. 1a and 1b). The external feedback on the left and the grating reflector 8 on the right side of gain section 20 provide optical feedbacks necessary for the resonance of photons in the external cavity laser.

Reflection grating 8 can be either a sampled grating or super-structured grating design. Such gratings exhibit a comb-like reflection spectrum as well, as shown as solid line in FIGS. 2a and 2b, with a free spectral range, the wavelength separation between adjacent reflection maxima, much larger than that of etalon 3. The spectra response from etalon 3 and sampled/superstructure grating 8 can provide two different sets of equal spaced wavelength selective combs (dashed and solid curves in FIGS. 2a and 2b) with different spacing having maxima transmission and reflection points as shown in FIGS. 2a and 2b.

With the arrangement of the laser device, at any given time only one 62 of the reflection peaks of sampled/superstructure grating 8 is made to overlap with one 61 of the transmission peaks of etalon 3 in the wavelength range of interest, as shown in FIG. 2b. With phase section 19 altered to provide a phase-matching coherent condition for lasing, such an overlap constructs a combined feedback maxima acting as wavelength selection for the external cavity laser, since amplitude of reflection from other comb peaks of either sampled grating/super-structure grating or external cavity (etalon 3 plus optical element 2) is not sufficient to cause any lasing.

When etalon 3 is arranged to have the peak transmission wavelength and a free-spectra range (FSR), i.e., the wavelength separation between neighboring transmission peaks, matching channel wavelength and spacing requirement of ITU grid for telecommunication, the wavelength of the laser is pre-defined to be ITU-compatible and no external wavelength control or reference is needed in operation.

The peak wavelength of the peak reflection is determined through a generic relation for a Bragg reflector by

λ=2·n_{eff}Λ (1)

where is λ is the wavelength of peak reflection of a Bragg grating, n_{eff} the effective mode index of the single mode waveguide, Λ the period of the Bragg reflection grating. Therefore the Bragg wavelength will be tuned if the refractive index of the waveguide is changed according to Eq. (1).

For sampled or superstructure grating 8, when electrodes 11&14 alter refractive index of the waveguide through thermal-optical or electro-optical effect, discussed above, the reflection wavelength of the sampled or superstructure grating will be tuned, i.e., the whole reflection spectrum will be shifted against the wavelength. However, as mentioned before, only a chosen reflection maxima 62 is aligned to the transmission peak 61 of etalon 3 at a time, and, maxima gain only happens at the overlapped wavelength. The laser wavelength in this configuration can only be tuned discretely to the maximum transmission points of the etalon spectrum, so the tuning of grating reflector 8 will make the lasing scan over all the ITU-grids within certain wavelength range when the ITU-compatible Etalon spectrum is kept constant.

FIGS. 3a (top view) and 3b (side view) shows a similar arrangement as FIGS. 1a (top view) and 1b (side view) with the addition of local heating elements 51 and 52 can be arranged on or near etalon 3 to adjust the refractive index of etalon 3 through thermal-optical effect, discussed above, which in turn can tune its spectrum response. In FIGS. 3a and 3b, heater 51 and 52 can be arranged on the surface of etalon 3 around an optical aperture of etalon 3. With both etalon 3 and sampled/superstructure grating 8 being aligned for their maxima first and tuned in a synchronized manner next, the laser wavelength can be continuously tuned. The tuning of etalon 3 can also be implemented through a local heater underneath or above it.

In some aspects, the whole external cavity laser assembly can be placed on a large TEC (thermoelectrically cooled) structure 48 to maintain a constant temperature condition for the laser under variable environments.

In general, the tunable laser device can provides a wide wavelength tunable laser structure with wavelength selection by matching the two spectrum responses between the etalon and the planar sampled/superstructure grating. In the external cavity configuration, a much narrower line-width can be achieved than conventional tunable DFB or DFB laser, which is an important consideration for next generation 40G/100 coherent communication.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

It is noted that, as used in this specification and the appended claims, the singular forms “a,” “an,” and “the,” include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Further, in describing representative embodiments of the present disclosure, the specification may have presented the method and/or process of the present disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequence may be varied and still remain within the spirit and scope of the present disclosure.

Any of the functions described as being performed by a module, component or system can in some embodiments be performed by one or more other modules, component or system. One or more functions described as being performed by different modules, components or systems can be combined to be performed by one or more common module, component or system.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

What is claimed is:

1. A wavelength tunable laser comprising:
an active portion comprising a photonic integrated circuit comprising an optical waveguide comprising an optical gain section, a grating section, a phase control section and an anti-reflection coating arranged at opposite ends of the optical waveguide;
a passive portion comprising an optical etalon and a reflective surface or mirror arranged to provide wavelength selective feedback to the active portion to generate beam of laser light; and
a controller arranged to control the active portion, the passive portion or both the active portion and the passive portion to generate tuning of the lasing wavelength.

2. The wavelength tunable laser according to claim 1, wherein the optical gain section is arranged between the grating section and the phase control section.

3. The wavelength tunable laser according to claim 1, wherein the passive portion comprising an optical element arranged to receive and collimate radiation emitted from the optical waveguide and provide the radiation to the optical etalon and a mirror comprising a reflective surface arranged to receive radiation transmitted by the optical etalon and reflect the radiation back to the optical etalon.

4. The wavelength tunable laser according to claim 1, wherein the gain section of the optical waveguide is arranged to create a spontaneous emission of photons over a bandwidth around a center frequency.

5. The wavelength tunable laser according to claim 1, wherein the grating section of the optical waveguide is arranged to partially reflect photons back to the optical gain section at selective wavelengths.

6. The wavelength tunable laser according to claim 1, wherein the phase section of the optical waveguide is arranged to control an optical path length and provide a coherent phase condition for the radiation.

7. The wavelength tunable laser according to claim 1, wherein the controller is arranged to control one or more electrodes coupled to the active portion to selectively adjust a refractive index of the active portion.

8. The wavelength tunable laser according to claim 1, wherein the controller is arranged to control one or more heating elements coupled to the active portion to selectively adjust a refractive index of the active portion.

9. The wavelength tunable laser according to claim 1, wherein the controller is arranged to control one or more electrodes coupled to the passive portion to selectively adjust a refractive index of the etalon.

10. The wavelength tunable laser according to claim 1, wherein the controller is arranged to control one or more heating elements coupled to the passive portion to selectively adjust a refractive index of the etalon.

11. The wavelength tunable laser according to claim 1, wherein the controller is arranged to allow the wavelength tunable laser to be operated continuously or selectively to produce radiation at a range of wavelengths.

12. The wavelength tunable laser according to claim 1, wherein the optical etalon includes a transmission spectrum that includes one or more comb-like maxima.

13. The wavelength tunable laser according to claim 1, wherein the optical etalon is arranged to provide a wavelength filter for the optical waveguide.

14. The wavelength tunable laser according to claim 1, wherein the grating section of the optical waveguide includes a sampled grating or a superstructure grating with a comb reflection structure.

15. The wavelength tunable laser according to claim 1, wherein the optical etalon and the grating are arranged to provide differently spaced wavelength sections having maxima transmission and reflection points providing a maximum reflection of an associated wavelength.

16. A wavelength tunable laser comprising:
an active portion comprising:
an optical waveguide comprising a phase control section near a first end, a grating section near a second end and a gain section arranged between the first and the second end of the waveguide, wherein the first end comprises a first antireflection coating and the second end comprising a second antireflection coating;
a passive portion comprising:
a first optical element arranged to receive and collimate radiation emitted from the optical waveguide;
an optical etalon;
a second optical element comprising a reflective surface arranged to receive radiation transmitted by the optical etalon and reflect the radiation back to the optical etalon; and
a controller arranged to control the active portion, the passive portion or both the active portion and the passive portion to generate tuning of the lasing wavelength.

17. The wavelength tunable laser according to claim 16, wherein the controller is arranged to control one or more electrodes, one or more heating elements, or both the one or more electrodes and the one or more heating elements coupled to the active portion, the passive portion, or both the active portion and the passive portion to selectively adjust a refractive index of the active portion, the passive portion, or both the active portion and the passive portion.

18. A method for wavelength tuning a laser comprising:
providing an active portion comprising a photonic integrated circuit comprising an optical waveguide comprising an optical gain section, a grating section, a phase control section and an anti-reflection coating arranged at opposite ends of the optical waveguide;
providing a passive portion comprising an optical etalon arranged to provide feedback to the active portion to generate beam of laser light; and
controlling, by a controller, the active portion, the passive portion or both the active portion and the passive portion to generate tuning of the lasing wavelength.

19. The method according to claim 18, wherein the controller is arranged to control one or more electrodes, one or more heating elements, or both the one or more electrodes and the one or more heating elements coupled to the active portion, the passive portion, or both the active portion and the passive portion to selectively adjust a refractive index of the active portion, the passive portion, or both the active portion and the passive portion.

20. A method for wavelength tuning a laser comprising:
providing a reflective grating section in an active portion of a laser system, wherein the grating section is arranged to partially reflect photons back to the active portion at selective wavelengths; and
providing an etalon in a passive portion of the laser system, wherein the etalon is arranged to include a transmission spectrum that functions as an wavelength filter and provides an external feedback to the active portion of the laser system.
